(19) United States
(12) Patent Application Publication
(10) Pub. No.: US 2015/0104148 A1
(43) Pub. Date: Apr. 16, 2015

(54) METHOD AND APPARATUS FOR REPLACING A COMMERCIAL IN A RECORDED PROGRAM

(71) Applicant: THOMSON LICENSING, Issy de Moulineaux (FR)

(72) Inventors: Chaminda JAYAMANNE, Fishers, IN (US); David John WEAVER, Fishers, IN (US); Martin Vincent DAVEY, Indianapolis, IN (US)

(73) Assignee: THOMSON LICENSING, Issy de Moulineaux (FR)

(21) Appl. No.: 14/055,563

(22) Filed: Oct. 16, 2013

(51) Int. Cl. G11B 27/28; G11B 27/10; G06Q 30/02; H04N 5/93

(52) U.S. Cl. CPC G11B 27/28; H04N 5/93; G11B 27/105; G06Q 30/0272
USPC 386/241; 386/296; 386/248

(57) ABSTRACT

A method of playing back, by an electronic device, a recorded program having a first commercial inserted therein is disclosed. The method comprises steps of if a date of playing back the recorded program is less than a date associated with the recorded program, playing back the recorded program including the first commercial; and if the date of playing back the recorded program is more than the associated date, replacing the first commercial in the recorded program with a second commercial and playing back the recorded program including the second commercial.

### BACKGROUND OF THE INVENTION

1. Field of the Invention

The present principles of the embodiments generally relate to a method and apparatus for replacing a commercial, as necessary, in a recorded program and more particularly replacing the commercial with another if a date of playing back the recorded program is more than a date associated with the recorded program.

2. Background Information

Audio and/or video apparatuses such as television receivers, digital video recorders (DVRs), personal video recorders (PVRs), and digital versatile disc (DVD) recording and playback devices may be used to record and playback audio and/or video content. Most programs received by an audio and/or video apparatus include commercials and a recording apparatus usually records a program with all the commercials inserted therein.

The term “commercial” as used herein refers to a commercial presented in a commercial break. That is, when a commercial is playing, the program that a user is viewing or listening to is interrupted.

A problem associated with a recorded program is that the commercials are the same each time the recorded program is played back. A commercial in a recorded program may be out of date. For example, a commercial advertising a sale may have ended at the time of a playback. Under this circumstance, no commercial effect is achieved and the viewer's time is wasted.

Accordingly, there is a need for a method and apparatus for replacing commercials as necessary at the time of a playback. The present invention addresses these and/or other issues.

### SUMMARY OF THE INVENTION

In accordance with an aspect of the present invention, a method of playing back, by an electronic device, a recorded program having a first commercial inserted therein is disclosed. The method comprises steps of if a date of playing back the recorded program is less than a date associated with the recorded program, playing back the recorded program including the first commercial; and if the date of playing back the recorded program is more than the associated date, replacing the first commercial in the recorded program with a second commercial and playing back the recorded program including the second commercial.

The associated date may be a date of recording the recorded program plus a predetermined number of days or a date included in metadata associated with the recorded program. The predetermined number of days may be user adjustable. The metadata may indicate whether the first commercial can be replaced and if the date of playing back the recorded program is more than the associated date and the metadata indicates that the first commercial can be replaced, replacing the first commercial in the recorded program with the second commercial and playing back the recorded program including the second commercial. The date included in the metadata may be the expiration date of the first commercial.

In one embodiment, the method further comprises receiving the metadata and the recorded program from a broadcast source.

In another embodiment, the method further comprises requesting the second commercial from a server and receiving from the server the second commercial. The requesting step may comprise sending an identification of the first commercial to the server.

In another embodiment, the method further comprises receiving the recorded program from a broadcast source; recording the recorded program; determining location information of the first commercial in the recorded program; and storing location information of the first commercial in a memory. The replacing step may comprise deleting the first commercial in the recorded program and inserting the second commercial according to the location information of the first commercial.

In another embodiment, the method further comprises receiving a user command to play back the recorded video program and the method further comprises determining location information of the first commercial in the recorded program in response to the user command and the replacing step comprises deleting the first commercial in the recorded program and inserting the second commercial according to the location information of the first commercial. The location information may be stored in a different file from the recorded program.

In yet another embodiment, the recorded program includes a third commercial and the method further comprises if the date of playing back the recorded program is more than a data associated with the third commercial, replacing the third commercial in the recorded program with a fourth commercial and playing back the recorded program including the fourth commercial.

In accordance with another aspect of the present invention, an electronic device capable of playing back a recorded program having a first commercial inserted therein is disclosed. The electronic device comprises a memory; and a processor executing software stored in the memory, wherein if a date of playing back the recorded program is less than a date associated with the recorded program, the processor is configured to play back the recorded program including the first commercial; and if the date of playing back the recorded program is more than the associated date, the processor is configured to replace the first commercial in the recorded program with a second commercial and play back the recorded program including the second commercial. The predetermined number of days may be user adjustable.

In one embodiment, the processor is configured to receive the metadata and the recorded program from a broadcast source. The metadata may indicate whether the first commercial can be replaced and if the date of playing back the recorded program is more than the associated date and the metadata indicates that the first commercial can be replaced, the processor is configured to replace the first commercial in the recorded program with the second commercial and play back the recorded program including the second commercial. The date included in the metadata may be the expiration date of the first commercial.

In another embodiment, the processor is configured to request the second commercial from a server and receive from the server the second commercial. The processor may be configured to request the second commercial by sending an identification of the first commercial to the server.

In another embodiment, the processor is configured to receive the recorded program from a broadcast source; record the recorded program; determine location information of the first commercial in the recorded program; and store the location information of the first commercial in a memory.

In another embodiment, the processor is configured to receive a user command to play back the recorded video program. The processor may be configured to determine location information of the first commercial in the recorded program in response to the user command and replace the first commercial by deleting the first commercial in the recorded program and inserting the second commercial according to the location information of the first commercial. The location information may be stored in a different file from the recorded program.

In yet another embodiment, the recorded program includes a third commercial and if the date of playing back the recorded program is more than a data associated with the third commercial, the processor is configured to replace the third commercial in the recorded program with a fourth commercial and play back the recorded program including the fourth commercial.

### DETAILED DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

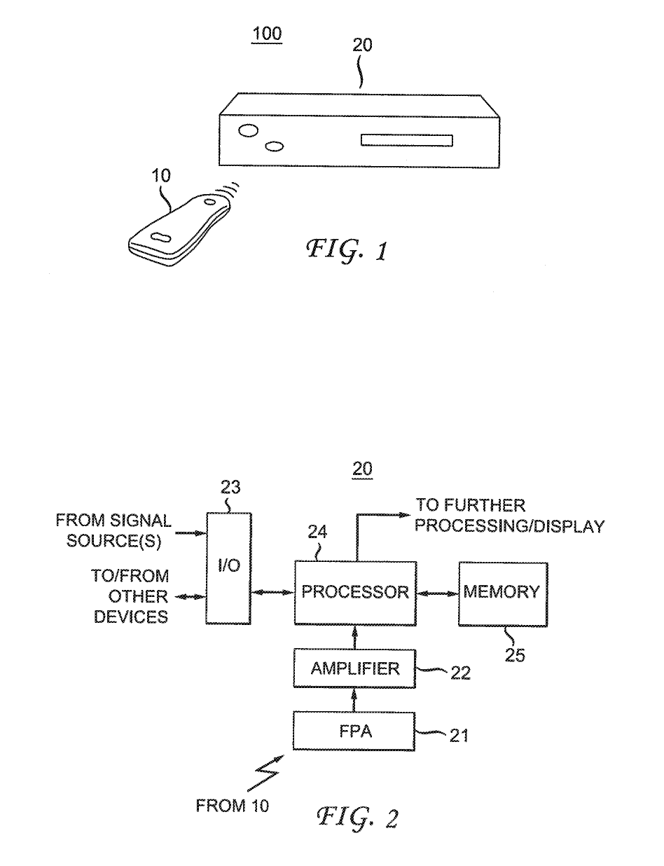

FIG. 1 shows an electronic device according to an exemplary embodiment of the present invention;

FIG. 2 shows a block diagram of the electronic device of FIG. 1 according to an exemplary embodiment of the present invention; and

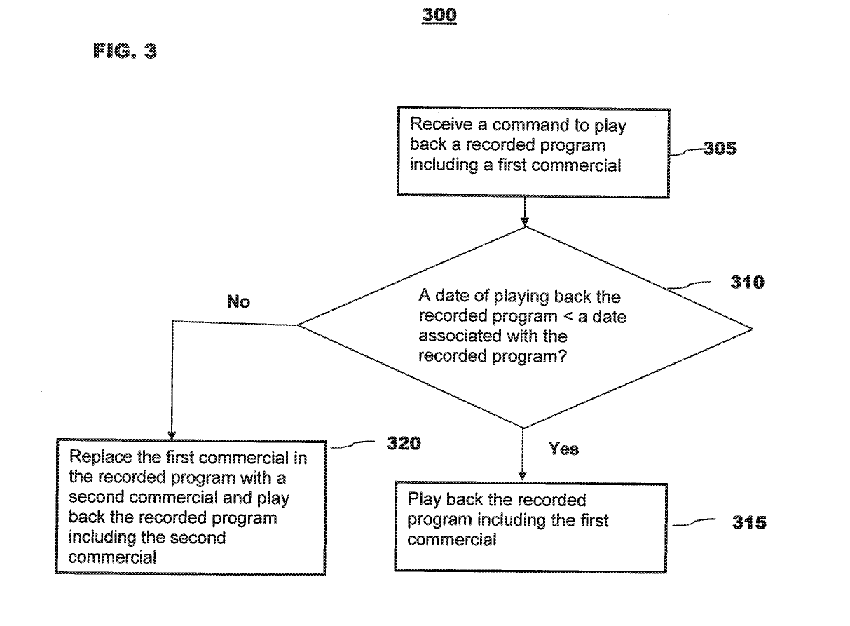

FIG. 3 shows a flow diagram for playing back, by an electronic device, such as electronic device 20 showing FIG. 1, a recorded video program having the first commercial inserted therein, according to an exemplary embodiment of the present invention.

The exemplifications set out herein illustrate preferred embodiments of the invention, and such exemplifications are not to be construed as limiting the scope of the invention in any manner.

### DETAILED DESCRIPTION

Referring now to the drawings, and more particularly to FIG. 1, an exemplary environment 100 suitable for implementing the present invention is shown. As indicated in FIG. 1, environment 100 comprises a user input device 10, and an electronic device 20 capable of tuning a channel for receiving broadcast programs, recording broadcast programs, and playing back recorded broadcast programs or programs recorded in a storage device connected to the electronic device 20, such as a CD, a DVD, a Blu-ray disk, a local hard disk, or a network storage. The electronic device 20 can also play back recorded programs from another playback device connected to the electronic device 20. According to an exemplary embodiment, electronic device 20 is embodied as a television signal receiver (e.g., set-top box, a Video Cassette Recorder (VCR), a personal video recorder (PVR), a hard disk recorder (HDR), or a digital video recorder (DVR), a Blu-ray player, etc.) without an integrated display device, but may be embodied as an apparatus or device that includes an integrated display device.

User input device 10 is operative or configured to generate and output control signals that control the operation of electronic device 20 and/or other devices. According to an exemplary embodiment, user input device 10 includes a plurality of input keys and outputs control signals in a wired and/or wireless (e.g., via infrared or radio frequency (RF) link, etc.) manner responsive to user depression of its input keys. User input device 10 may for example be embodied as a hand-held remote control device, wired and/or wireless keyboard, integrated control panel of electronic device 20, and/or other user input device.

Electronic device 20 is operative or configured to receive signals including audio, video and/or data signals having one or more types of analog modulation (e.g., NTSC, PAL, SECAM, etc.) and one or more types of digital modulation (e.g., QPSK, QAM, VSB, etc.) from one or more broadcast sources such as cable, terrestrial, satellite, internet and/or other signal sources and to provide aural/visual, aural only, and/or visual only outputs corresponding to these received signals.

Electronic device 20 is operative or configured to allow instant, time-shift and timer recordings. Time-shift recording is a system that is used temporarily to store broadcast signals for later viewing, instant recording is a system for immediate recording and timer recording is a system that is used for predefined, later recording of media content. According to the principles of the embodiments, electronic device 20 is operative or configured to detect a first commercial inserted in a first program, stores location information of the first commercial, records the first program without the first commercial as a recorded program, play back the recorded program, and insert a second commercial during the playback at a first location according to the stored location information.

Electronic device 20 is also operative or configured to process received signals and provide the resulting processed signals to one or more other devices, and to receive signals from other devices, such as a DVD player, a VCR, a PVR, a HDR, a DVR, a Blu-ray player, or a storage device.

In one embodiment, the electronic device 20 is operative or configured to play back a recorded program having a first commercial inserted therein. If a date of playing back the recorded program is less than a date associated with the recorded program, the electronic 20 is operative or configured to play back the recorded program including the first commercial and if the date of playing back the recorded program is more than the associated date, the electronic 20 is operative or configured to replace the first commercial in the recorded program with a second commercial and play back the recorded program including the second commercial. The associated date may be the recording date of the recorded program plus a predefined number of days, such as 30 days. It may be a date specified by a server providing the broadcast program or another server accessible, for example, through the Internet, from which the recorded program is recorded.

Referring to FIG. 2, a diagram providing further details of the electronic device 20 of FIG. 1 according to an exemplary embodiment of the present invention is shown. Electronic device 20 of FIG. 2 comprises front panel means such as front panel assembly (FPA) 21, amplifying means such as amplifier 22, and input/output (I/O) means such as I/O block 23, processing means such as processor 24, and memory means such as memory 25. Some of the foregoing elements of FIG. 2 may be embodied using integrated circuits (ICs), and some elements may for example be included on one or more ICs. For clarity of description, certain conventional elements associated with electronic device 20 such as certain control signals, power signals and/or other elements may not be shown in FIG. 2.

FPA 21 is operative or configured to receive user inputs from user input device 10, and to output signals corresponding to the user inputs to amplifier 22. According to an exemplary embodiment, FPA 21 receives signals, such as IR and/or RF signals, from user input device 10 and generates corresponding signals which are output to amplifier 22. Amplifier 22 is operative to amplify the signals provided from FPA 21 for output to processor 24.

I/O block 23 is operative or configured to perform I/O functions of electronic device 20. According to an exemplary embodiment, I/O block 23 is operative or configured to receive signals such as audio, video and/or data signals in analog and digital modulation formats from one or more broadcast signal sources or servers such as cable, terrestrial, satellite, internet and/or other signal sources or servers. Although not expressly shown in FIG. 2, I/O block 23 may include a plurality of input terminals each designated to receive signals from a given broadcast signal source. For example, I/O block 23 may include separate input terminals for receiving signals from cable, antenna (i.e., terrestrial), satellite, internet and/or other signal sources. I/O block 23 is also operative to output processed signals to one or more other devices connected to the electronic device 20, and to receive signals from such devices. Devices connected to the electronic device 20 may include DVD players, VCRs, PVRs, HDRs, DVRs, Blu-ray players, and/or storage devices.

Processor 24 is operative or configured to perform various signal processing and control functions of electronic device 20. According to an exemplary embodiment, processor 24 processes the audio, video and/or data signals provided from I/O block 23 by performing functions including channel tuning, analog and digital demodulation, and other functions to thereby generate data representing audio, video and/or data content. The data produced from such processing functions may be provided for further processing (e.g., MPEG decoding, etc.) and output. Also according to an exemplary embodiment, processor 24 detects and processes user inputs provided via user input device 10, and may control its own operations and/or output control signals to control other elements of electronic device 20 (including elements not shown in FIG. 2) responsive to such user inputs.

Processor 24 is also operative or configured to execute software code stored, for example, in memory 25, to play back a recorded program having a first commercial inserted therein. If a date of playing back the recorded program is less than a date associated with the recorded program, processor 24 is operative or configured to execute the software code to play back the recorded program including the first commercial and if the date of playing back the recorded program is more than the associated date, processor 24 is operative or configured to execute the software code to replace the first commercial in the recorded program with a second commercial and play back the recorded program including the second commercial. The associated date may be the recording date of the recorded program plus a predefined number of days, such as 30 days. It may be a date specified by a server providing the broadcast program or another server accessible, for example, through the Internet, from which the recorded program is recorded.

Memory 25 is operative or configured to perform data storage functions of electronic device 20. According to an exemplary embodiment, memory 25 stores data including, but not limited to, software code, electronic program guide (EPG) data, user preference data, recorded audio/video programs, recorded audio only programs, recorded video only programs, and/or other data. Memory 25 may include volatile and/or non-volatile memory regions and storage devices such hard disk drives, DVD drives.

Referring to now FIG. 3, an exemplary process 300 for playing back, by an electronic device, such as electronic device 20, a recorded video program having a first commercial inserted therein, according to the principles of the embodiments of the invention, is shown. The recorded program can be audio, video, or both.

At step 305, the processor 24 is operative or configured to receive a command to play back a recorded program. The command to play back may be generated by a user selecting one of the recorded programs stored in the memory 25 or a storage device (not shown), such as a USB drive, connected to the electronic device 20 through the I/O block 23.

At step 310, the processor 24 is operative or configured to determine if a date of playing back the recorded program is less than a date associated with the recorded program, and if the date of playing back is less than the associated date, the processor 24 is operative or configured to play back the recorded program including the first commercial at step 315.

If the date of playing back the recorded program is more than the associated date, the processor 24 is operative or configured to replace the first commercial in the recorded program with a second commercial and play back the recorded program including the second commercial at step 320.

In one embodiment, the replacing step 320 comprises deleting the first commercial in the recorded program and inserting the second commercial.

In one embodiment, the associated date is the date of recording the recorded program plus a predetermined number of days, for example, 30 days. The predetermined number of days may be user adjustable. In another embodiment, the associated date is a date included in the metadata associated with the recorded program for the first commercial or all commercials included in the recorded program. The metadata is data sent from a broadcast source or server. The broadcast source or server can be the one that delivered a program from which the recorded program is recorded. As indicated previously, the broadcast source or server can be a server accessible through the Internet. The metadata can be part of the electronic program guide (EPG) data. For each program, the associated date is included as part of the program information in the EPG. In one embodiment, for each program, the EPG provides the associated date for each commercial inserted in the program. The associated date represents the expiration date of the associated commercial. In another embodiment, the associated date in the EPG represents the expiration date of all the commercials included in the recorded program. Mechanism for sending an EPG using MPEG II, ATSC, DVB, and other standards is well known in the art and will not be further illustrated for the purposes of simplicity.

In one embodiment, for each commercial inserted in a program, the EPG also indicates whether the commercial can be replaced. The EPG may provide an indicator indicating whether all of the commercials can be replaced. This mechanism gives an advertiser more control of the commercials. If the EPG indicates that the first commercial cannot be replaced, even if the date of playing back the recorded program is more than the associated date, the processor 24 is operative or configured to skip the replacing step 320. The processor 24 is operative or configured to perform the replacing step 320 only if the date of playing back the recorded program is more than the associated date and the metadata (e.g., the electronic program guide) indicates that the first commercial can be replaced.

In one embodiment, the recorded program is not modified. In another embodiment, the recorded program is modified, so that the next time, the recorded is played back, instead of the first commercial, the second commercial is included in the recorded program for playback.

The processor 24 may request a copy of the second commercial from a broadcast source or a server, which may be the same or different broadcast source or server supplying the program from which the recorded program is recorded. The processor 24 should include in the request an identification of the first commercial. The identification can be program information of the recorded program, such as program title of the recorded program. The identification of the first commercial may also include ordinal number of the first commercial among all the commercials included in the first program. The identification can also be included in the metadata (e.g., an electronic program guide). In response to the request, the broadcast source or server sends a copy of the second commercial. If the identification includes only program information, the server may send a group of commercials related to the recorded program for the processor 24 to select one of the received commercials as the second commercial. The server may analyze what type of audience would be interested in viewing or listening to the recorded program and select the group of commercials more suited for this type of audience. The processor 24 may select a predefined one, select a different one each time the recorded program is played back, or randomly select one of the received commercials as the second commercial.

In order to replace the first commercial, the processor 24 should know the location information of the first commercial, for example, by detecting the first commercial in the recorded program or obtaining from the metadata, such as the program information in an EPG. In one embodiment, the processor 24 determines location information of the first commercial in the recorded program in response to the user command and the replacing step 320 comprises deleting the first commercial in the recorded program and inserting the second commercial according to the determined location information of the first commercial.

The processor 24 may receive the recorded program from a broadcast source or server, record the recorded program, determine location information of the first commercial in the recorded program, and store the location information of the commercial in a memory, such as memory 25. The location information should be stored in a different file from the recorded program.

In another embodiment, the recorded program may include a third commercial. The processor 24 determines if the date of playing back the recorded program is more than a data associated with the third commercial. If date of playing back the recorded program is more than the date associated with the third commercial, the processor 24 replaces the third commercial in the recorded program with a fourth commercial and plays back the recorded program including the fourth commercial. If the date of playing back the recorded program is less than the date associated with the third commercial, the processor 24 does not replace the third commercial in the recorded program with a fourth commercial and plays back the recorded program including the third commercial. Like the first commercial, if the metadata indicates that the third commercial cannot be replaced, the processor 24 should not replace the third commercial even if the date associated with the third commercial is less than the date of playing back the recorded program. Like the first commercial, the date associated with the third commercial can be the date of recording the recorded program plus a predetermined number of days, for example, 30 days, which may be user adjustable, or a date included in the metadata associated with the recorded program for the third commercial.

The recorded program may be an audio/video signal, such as a television program, a video only signal, such as a commercial, or an audio only signal, such as a song.

The broadcast source may be a cable, terrestrial, satellite, internet and/or another signal source. A broadcast source may also serve as a server for transmitting commercials in addition to programs.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of playing back, by an electronic device, a recorded program having a first commercial inserted therein, the method comprising:
if a date of playing back the recorded program is less than a date associated with the recorded program, playing back the recorded program including the first commercial; and
if the date of playing back the recorded program is more than the associated date, replacing the first commercial in the recorded program with a second commercial and playing back the recorded program including the second commercial.

2. The method of claim 1, wherein the associated date is a date of recording the recorded program plus a predetermined number of days.

3. The method of claim 1, wherein the associated date is a date included in metadata associated with the recorded program.

4. The method of claim 3, further comprising receiving the metadata and the recorded program from a broadcast source.

5. The method of claim 3, wherein the metadata indicates whether the first commercial can be replaced and if the date of playing back the recorded program is more than the associated date and the metadata indicates that the first commercial can be replaced, replacing the first commercial in the recorded program with the second commercial and playing back the recorded program including the second commercial.

6. The method of claim 3, wherein the date included in the metadata is the expiration date of the first commercial.

7. The method of claim 1, further comprising requesting the second commercial from a server and receiving from the server the second commercial.

8. The method of claim 7, wherein the requesting step comprises sending an identification of the first commercial to the server.

9. The method of claim 1, wherein the predetermined number of days is user adjustable.

10. The method of claim 1, further comprising:
receiving the recorded program from a broadcast source;
recording the recorded program;
determining location information of the first commercial in the recorded program; and
storing the location information of the first commercial in a memory.

11. The method of claim 10, wherein the replacing step comprises deleting the first commercial in the recorded program and inserting the second commercial according to the location information of the first commercial.

12. The method of claim 1, further comprising receiving a user command to play back the recorded video program.

13. The method of claim 12, further comprising determining location information of the first commercial in the recorded program in response to the user command and the replacing step comprises deleting the first commercial in the recorded program and inserting the second commercial according to the location information of the first commercial.

14. The method of claim 12, wherein the location information is stored in a different file from the recorded program.

15. The method of claim 1, wherein the recorded program includes a third commercial and the method further comprises if the date of playing back the recorded program is more than a data associated with the third commercial, replacing the third commercial in the recorded program with a fourth commercial and playing back the recorded program including the fourth commercial.

16. An electronic device capable of playing back a recorded program having a first commercial inserted therein, the electronic device comprising:
a memory; and
a processor executing software stored in the memory, wherein if a date of playing back the recorded program is less than a date associated with the recorded program, the processor is configured to play back the recorded program including the first commercial; and if the date of playing back the recorded program is more than the associated date, the processor is configured to replace the first commercial in the recorded program with a second commercial and play back the recorded program including the second commercial.

17. The electronic device of claim 16, wherein the associated date is a date of recording the recorded program plus a predetermined number of days.

18. The electronic device of claim 16, wherein the associated date is a date included in metadata associated with the recorded program.

19. The electronic device of claim 18, wherein the processor is configured to receive the metadata and the recorded program from a broadcast source.

20. The electronic device of claim 18, wherein the metadata indicates whether the first commercial can be replaced and if the date of playing back the recorded program is more than the associated date and the metadata indicates that the first commercial can be replaced, the processor is configured to replace the first commercial in the recorded program with the second commercial and play back the recorded program including the second commercial.

21. The electronic device of claim 18, wherein the date included in the metadata is the expiration date of the first commercial.

22. The electronic device of claim 16, wherein the processor is configured to request the second commercial from a server and receive from the server the second commercial.

23. The electronic device of claim 22, wherein the processor is configured to request the second commercial by sending an identification of the first commercial to the server.

24. The electronic device of claim 16, wherein the predetermined number of days is user adjustable.

25. The electronic device of claim 16, wherein the processor is configured to receive the recorded program from a broadcast source; record the recorded program; determine location information of the first commercial in the recorded program; and store the location information of the first commercial in a memory.

26. The electronic device of claim 25, wherein the processor replaces the first commercial by deleting the first commercial in the recorded program and inserting the second commercial according to the location information of the first commercial.

27. The electronic device of claim 16, wherein the processor is configured to receive a user command to play back the recorded video program.

28. The electronic device of claim 27, wherein the processor is configured to determine location information of the first commercial in the recorded program in response to the user command and replace the first commercial by deleting the first commercial in the recorded program and inserting the second commercial according to the location information of the first commercial.

29. The electronic device of claim 27, wherein the location information is stored in a different file from the recorded program.

30. The electronic device of claim 16, wherein the recorded program includes a third commercial and if the date of playing back the recorded program is more than a data associated with the third commercial, the processor is configured to replace the third commercial in the recorded program with a fourth commercial and play back the recorded program including the fourth commercial.
